(19) United States
(12) Patent Application Publication
(10) Pub. No.: US 2013/0109784 A1
(43) Pub. Date: May 2, 2013

(54) AQUEOUS RADIATION-CURABLE EPOXY ACRYLATE DISPERSIONS

(71) Applicants: Juergen Baro, Esslingen (DE); Laurence Druene, Perthes en Gatinais (FR); Paul Birnbrich, Solingen (DE); Hans-Josef Thomas, Korschenbroich (DE)

(72) Inventors: Juergen Baro, Esslingen (DE); Laurence Druene, Perthes en Gatinais (FR); Paul Birnbrich, Solingen (DE); Hans-Josef Thomas, Korschenbroich (DE)

(21) Appl. No.: 13/497,457

(22) PCT Filed: Sep. 13, 2010
(86) PCT No.: PCT/EP10/05601

§ 371 Date: Mar. 21, 2012

(30) Foreign Application Priority Data
Sep. 21, 2009 (EP) 09290721.1

(51) Int. Cl. C09D 163/00

(52) U.S. Cl. CPC C09D 163/00
USPC 523/427

(57) ABSTRACT

The invention relates to aqueous radiation-hardenable epoxy acrylate dispersions comprising (a) an epoxy acrylate resin (P*) with at least two acrylate groups per molecule, wherein at 25 degrees Celsius, said epoxy acrylate resin is not self-disperging in water; and (b) a dispergator (D*) with at least one acrylate group per molecule, wherein said dispersions can be produced by converting, in a first step (i), in the presence of a catalyst if need be, one or several compounds (A) selected from the group of non-ionic compounds having a HLB value of less than 12, and containing at least two oxirane groups per molecule, with one or several compounds (B) selected from the group of non-ionic compounds having a HLB value in the range from 12 to 20, and which contain at least one h-acid group (ZH) per molecule. The compounds (A) and (B) are employed at an equivalence ratio EpO (A):ZH (B) in the range from 1.3:1 to 400:1, and in a second step (ii), the reactive mixture thus obtained is converted, in the presence of a catalyst if need be, with one or several non-ionic compounds having a HLB value of less than 12, and containing at least two oxirane groups per molecule (compounds A), and with one or several compounds (C) selected from the group of non-ionic compounds having a HLB value of less than 12, and which contain at least two H-acid groups. The compounds (A) and (C) are employed at an equivalence ratio EpO (A):ZH (C) in the range from 1.1:1 to 20:1. In a third step (iii), the reactive mixture thus obtained is converted, in the presence of a catalyst if need be, with acrylic acid by ring opening of all epoxy groups. In a fourth step (iv), the reactive mixture thus obtained is disperged in water.

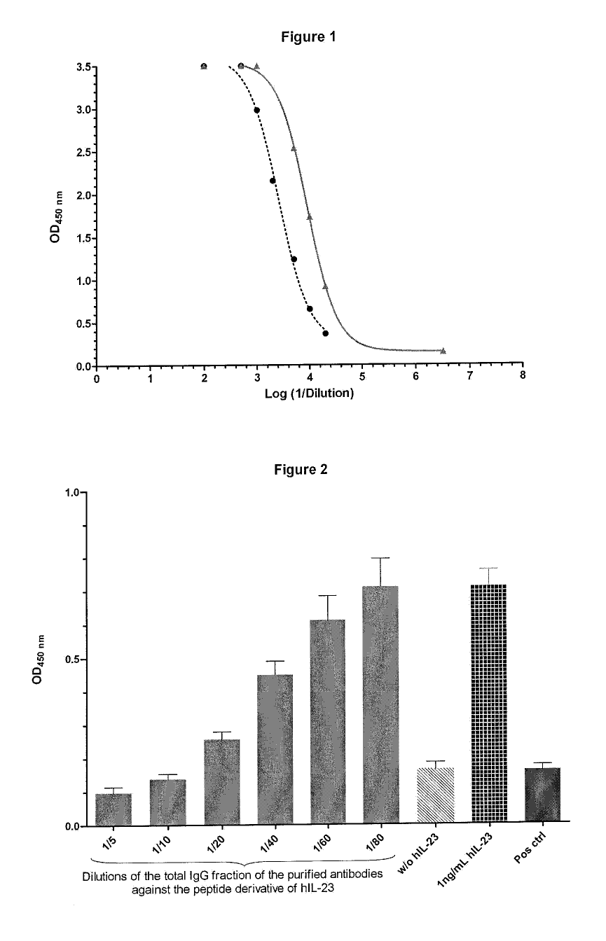

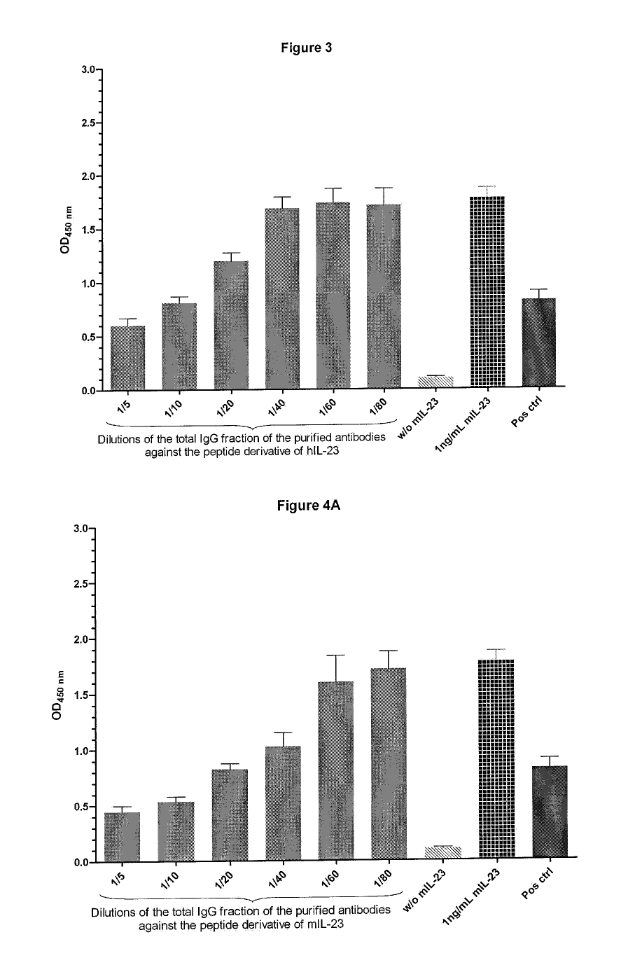

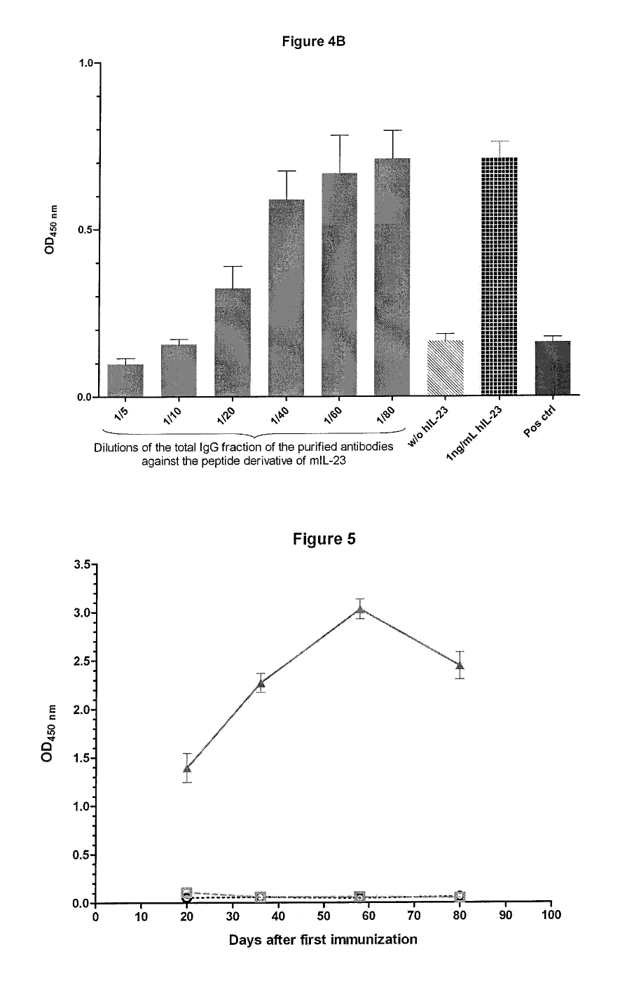

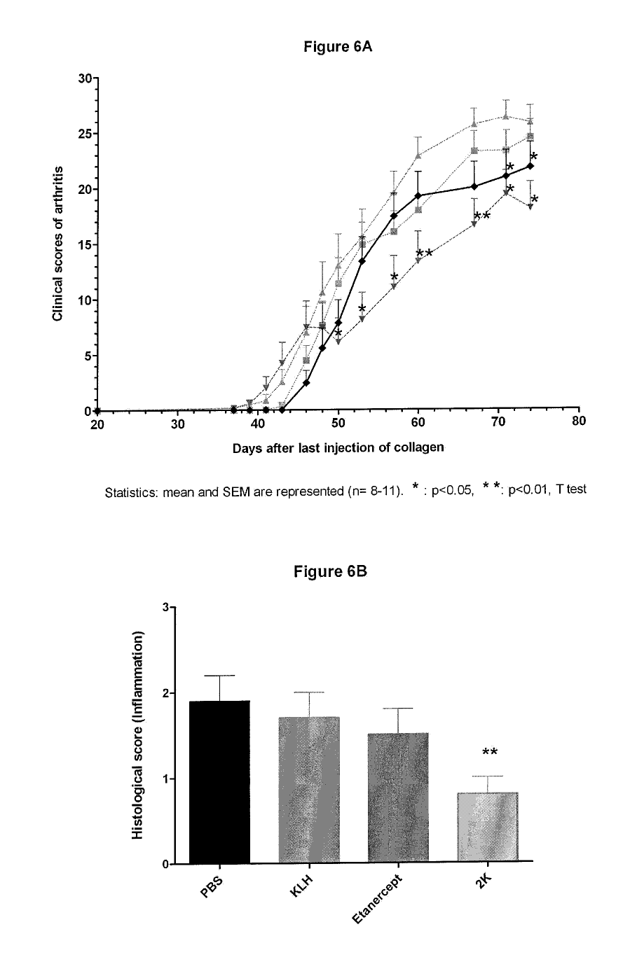

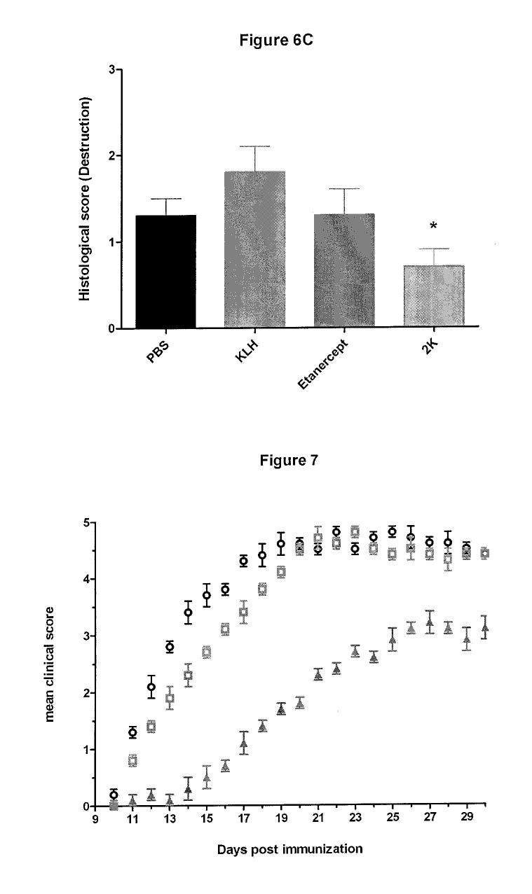

### FIELD OF THE INVENTION

The invention relates to radiation-curable, storage-stable epoxy acrylate dispersions containing special epoxy acrylate resins and special dispersants.

### PRIOR ART

Since the late 1990s, radiation-curable aqueous dispersions have been given special attention, especially because water as a solvent is particularly attractive for environmental reasons. Nevertheless, in this market segment there is a constant need for dispersions with improved properties. The technology hitherto in the area in question here is characterized by polyurethane acrylates. In contrast, epoxy acrylates have hardly appeared in this field until now. Particularly, because epoxy acrylates—so far almost exclusively reaction products of bisphenol-A diglycidyl ether and derivatives thereof with acrylic acid—could only be dispersed under special difficulties in water.

K.-D. Suh et al. describe in Polymer Bulletin 36, 141-148 (1996) the production of epoxy acrylates, which were obtained by reacting the epoxy resin bisphenol-A diglycidyl ether with acrylic acid. The authors report that the production of stable aqueous epoxy acrylate dispersions of this type by mere physical emulsification processes is difficult. To prepare aqueous dispersions of epoxy acrylates, they used mixtures of nonionic surfactants and cosurfactants. Sorbitan monolaurate, sorbitan monopalmitate, sorbitan monooleate were used as surfactants and cetyl alcohol or stearyl alcohol as co-surfactants. The use of larger quantities of such surfactants for the dispersion of the epoxy acrylates is however not much attractive for technical applications, because larger quantities of these surfactants have negative effects on the material properties of coatings, which are obtainable using such epoxy acrylate dispersions.

WO 2006/056331 discloses radiation-curable aqueous coating compositions containing an amount of epoxy acrylates, said compositions being obtainable by reacting at 20° C. in aqueous systems self-dispersing epoxy resins with acrylic and/or methacrylic acid, and by subsequently dispersing the thus obtained epoxy acrylates in an aqueous system. The storage stability of epoxy acrylate dispersions obtainable according to WO 2006/056 331 is only a few days and is therefore unsatisfactory from a practical point of view.

### DESCRIPTION OF THE INVENTION

It was an object of the present invention to provide aqueous epoxy acrylate dispersions with good practical storage stability. This means that the dispersions are stable at room temperature (25° C.) for at least three months, i.e. do no show signs of settling or phase separation during this period. Preferably, the storage stability should be at least six months at room temperature (25° C.). The epoxy acrylate dispersions to be developed should also, after physical drying but prior to radiation curing, provide tack-free coatings, and thus ensure a smooth processing on coating systems by sufficiently high levels of hardness. The hardness can be measured by various methods known to the person skilled in the art, for example using the pendulum hardness.

The epoxy acrylate resins for use in the context of the present invention are hydrophobic in nature, which is characterized by the fact that they are not self-dispersing at 25° C. in water.

It is noted that in the context of the present invention, the term “dispersion” is used. Within the scope of the present invention this term also includes the term emulsion. This expresses that, in the context of the present invention, there is no academic distinction between the terms dispersion and emulsion. The present invention rather involves “inclusion” of compounds in an aqueous environment, which can be done by way of a dispersion or an emulsion. Accordingly, the terms dispersion, dispersed, dispersant, et cetera, are used throughout in order to use a uniform terminology, however, in all cases dispersion and/or emulsion, dispersing and/or emulsifying, dispersant and/or emulsifier, et cetera, is meant. Clearly, the use of this terminology serves readability. The terms O/W dispersion (oil-in-water dispersion) and W/O dispersion (water-in-oil dispersion) logically also include O/W emulsions (oil-in-water emulsions) and W/O emulsions (water-in-oil emulsions), respectively.

It is further clarified that the term “acrylic acid” in the context of the present invention includes both acrylic acid and methacrylic acid or mixtures of acrylic and methacrylic acid. Again, the terminology used here serves linguistic simplification.

The HLB value within the scope of the present invention is understood to be the classical definition according to Griffin. For this value this formula applies:

HLB−20×(1−Ml/M)

where Ml is the molar mass of the hydrophobic portion of the molecule and M is the molar mass of the entire molecule.

The term oxirane group as used in the context of the present invention exactly corresponds to what is understood in organic chemistry by those skilled in the art: an oxirane group is an oxacyclopropane group. Oxirane groups are referred to in the literature as “epoxy groups” because epoxides are compounds containing oxirane groups. The compounds (A) contain oxirane groups. The compounds (B) contain no oxirane groups. The compounds (C) also contain no oxirane groups.

Functional groups in organic molecules can be positioned “terminally” or “internally”. “Terminal” means that a group is located at the end of a carbon chain. “Internal” means that a group is located on a spot within the molecule, which is non-terminal. This nomenclature to describe the position of functional groups, which the person skilled in the art is familiar with, is also used in the present invention.

It has surprisingly been found that a mutually tuned system of acrylated dispersant and epoxy acrylate resin, wherein the phase inversion temperature of the aqueous system is above 50° C., with respect to the storage stability of the resulting dispersion and the non-tackiness of physically dried but not yet radiation-cured coatings satisfies the above requirements in every sense.

The dispersions according to the present invention are further characterized by their good manageability and applicability (=incorporation into useful systems from an application point of view) and are suitable for coating various substrates, particularly wood, plastics, metals, paper, cardboard, glass, ceramics, leather and textiles by spraying, pouring, rolling, smearing, knife coating and immersing.

An object of the invention is related to aqueous radiation-curable epoxy acrylate dispersions containing

(a) an epoxy acrylate resin (P*) having at least 2 acrylate groups per molecule, said epoxy acrylate resin being not self-dispersing in water at 25° C., and
(b) a dispersant (D*) having at least one acrylate group per molecule,
wherein these dispersions are obtainable by
in a first step (i)
reacting one or more compounds (A), which are selected from the group of nonionic compounds having an HLB value of less than 12 and having at least two oxirane groups per molecule, with
one or more compounds (B), which are selected from the group of nonionic compounds having an HLB value in the range of 12 to 20 and having per molecule at least one H-acidic group (ZH)

optionally in the presence of a catalyst—in which process the compounds (A) and (B) are applied in an equivalent ratio EpO (A):ZH (B) in the range of 1.3:1 to 400:1, reacting the obtained reaction mixture, in a second step (ii)
with one or more nonionic compounds, having an HLB value of less than 12 and having per molecule at least two oxirane groups (compounds A), and
with one or more compounds (C), which are selected from the group of nonionic compounds having an HLB value of less than 12, and having per molecule at least two H-acidic groups,

optionally in the presence of a catalyst—in which process the compounds (A) and (C) are applied in an equivalent ratio EpO (A):ZH C) in the range of 1.1:1 to 20:1,

reacting the obtained reaction mixture, in a third step (iii)

optionally in the presence of a catalyst—with acrylic acid under ring opening of all epoxy groups,

in a fourth step (iv) dispersing the obtained reaction mixture in water.

Is it pointed out in particular that the above formulation “the obtained reaction mixture”, which is used several times, always refers to the mixture which is present at the end of the reaction which takes place in the relevant process step. The expression “the obtained reaction mixture” always has this meaning in the present invention.

In an embodiment, the amount of dispersant (D*)—based on the amount of epoxy acrylate resin (P*)—is at most 10 weight %. The dispersions according to the present invention have the following advantages:
The coatings produced therefrom by radiation curing have an extremely good thermal and chemical resistance.
The coatings produced therefrom by radiation curing have excellent gloss.
The coatings produced therefrom by radiation curing result in a very excellent hardness, which is better than that of urethane acrylate-based systems. Even prior to radiation curing, the coatings demonstrate, by pure physical drying, a very good hardness, i.e. they already lead to tack-free coatings prior to radiation curing.
The coatings produced therefrom by radiation curing show a high crosslink density. In other words, at curing an integrated network form.
The dispersions can have a very high solids content. Values ranging from 10 to 70 weight %—and particularly 25 to 60 weight %—solids content of the aqueous dispersions based on the total dispersion—are preferred. The high solids content has the advantage that less water needs to be evaporated during the curing process, which improves the cure speed and decreases the energy consumption for evaporation of the water.
Contrary to polyurethane acrylates, which generally are put to weakly basic pH-values ranging from 7-8 using amines and are because of that dispersed ionically, and which therefore are very sensitive to pH variations, which is reflected in the instability of the dispersions as well as in the undesirable odors by released amine, the novel nonionic epoxy acrylate dispersions are relatively insensitive to pH variations.
The minimum film forming temperature is below 20° C., so that homogeneous film forming is possible at moderate temperatures without the explicit need to add a coalescing agent.
The colloidal stability is very high. This is not only reflected in the already mentioned good storage stability under standard conditions (at least three months and preferably at least 6 months at 25° C.), but it is also clear that even very stringent storage conditions do not negatively affect the dispersions: studies, for instance, have shown the applicant that a 30-day storage at 60° C., or a multiple cyclic changing of the temperature in the range of 4° C. to 60° C., leaves the dispersions virtually unchanged (indicative of this is that the D50-values of particle size and the viscosity under these test conditions did not significantly change).

For a better understanding of the present invention the following is explained:

This invention is about preparing aqueous dispersions of epoxy acrylates, wherein these dispersions have the positive properties mentioned in the problem statement. The aqueous epoxy acrylate dispersions according to the present invention thus contain—in global terms—water, epoxy acrylate (P*) and dispersant (D*). The abbreviation (P*) for epoxy acrylate is chosen because epoxy acrylates are polymers. During the preparation of the aqueous epoxy acrylate dispersions according to the present invention, three synthetic building blocks are important: the compounds (A) on the one hand are the building blocks for the dispersant (D*) and on the other hand for the polymer (P*). The compounds (B), which contain a hydrophilic structural element, are building blocks for the dispersant (D*). The compounds (C) are building blocks for the polymer (P*).

From the reaction between A and B, a precursor of the dispersant (D*) is formed, which can be schematically represented by the equation A+B→D. Within the scope of the present invention, it is of major importance that this reaction takes place in a separate reaction step. It takes place in step (i). Since A in step (i) is used in excess, the reaction mixture obtained ex (i) contains a mixture of A and D. (D*) is understood to be the dispersant in the final dispersion, which is characterized by acrylate functionality; in contrast, (D) is understood to be a corresponding non-acrylated form that is present at the end of stage (i).

From the reaction of A and C a precursor of the polymer to be dispersed is formed, which can be schematically expressed by the reaction equation A+C→P. This reaction takes place in step (ii). Since the mixture (i.e. A+D) obtained in step (i) is used in step (ii), one could for stage (ii) more precisely write A+C+D→P+D+D′. Thus, D appears on both sides of the equation, which expresses that D, which has already been produced in step (i), to a large extent remains unchanged in step (ii), however, it is to a certain extent oligomerized, whereby D′ is formed. Since A in step (ii) is used in excess, the reaction mixture obtained ex (ii) contains a mixture of A, P, D and D′. (P*) is understood to be the present polymer in the final dispersion, which is characterized by acrylate functionality; in contrast, (P) is understood to be the corresponding non-acrylated form and it holds that (P*) in step (iii) is formed by acrylation of (P). Analogously, (D*) in step (iii) is formed by acrylation of (D) and (D′).

In an embodiment, step (iv) is performed in two steps, namely as follows: the reaction mixture obtained in step (iii) is
dispersed in water in a step (iv-a) under formation of a W/O dispersion, and
the resulting W/O dispersion in a step (iv-b)—optionally under addition of further water—is further cooled until it reaches the phase inversion temperature, whereby an O/W dispersion is formed. Preferably, in this case the phase inversion temperature is above 50° C.

The steps (i) and (ii) are preferably carried out under an atmosphere of inert gas, in particular nitrogen.

The intermediate obtained at the end of step (i), i.e. the reaction mixture obtained at the end of step (i), can—preferably under an inert gas such as nitrogen—be bottled and be stored before further processing in step (ii); the intermediate can however also be further processed immediately, i.e. it can be supplied directly to the step (ii). The steps (ii) to (iv) are preferably carried out in the same reactor, which must not be identical to the reactor of step (i).

Step (i) is preferably carried out at temperatures ranging from 90 to 150° C. and in particular 120 to 150°, preferably in the presence of a catalyst. The reaction of step (i) is then completed when the H-acidic groups of the compounds (B) are consumed, i.e. have reacted under ring opening of the oxirane groups present in the system. This is readily evident from the fact that the epoxide content of the mixture no longer decreases. The course of the reaction can therefore be controlled in a simple manner on the basis of the epoxide. Once the desired epoxide content is reached, the reaction mixture is cooled, suitably to a temperature at which the mixture is still liquid. In this liquid form, the mixture can be stored for an extended period of time, which is understood to include a period of up to about 12 months, before it is being further processed in step (ii). It may be useful to dilute the reaction mixture obtained from (i) by adding a further amount of compound (A) and by further cooling it in this way, as merely cooling without dilution would lead to solidification of the mixture. In this way, it is ensured that the thus diluted mixture on the one hand remains liquid during storage and on the other hand chemically stable, i.e. further undesirable reactions within the mixture do not occur. It is emphasized that the amount of (A), which is added to the final reaction mixture of step (i) for dilution purposes, is not to be considered for the above given equivalence ratio with respect to step (i), but certainly for the equivalence ratio with respect to step (ii).

In step (i), as already indicated, the compounds (A) and (B) are applied in an equivalent ratio EpO (A):ZH (B) in the range of 1.3:1 to 400:1. The term “EpO (A)” denotes the oxirane groups of the compounds (A). Accordingly, the term “ZH (B)” denotes the H-acidic groups of the compounds (B). In an embodiment, the compounds (A) and (B) in step (i) are used in an equivalent ratio EpO (A):ZH (B) in the range of 1.5:1 to 50:1. More preferably, the compounds (A) and (B) are used in an equivalent ratio EpO (A):ZH (B) in the range of 10:1 to 40:1 and in particular 15:1 to 30:1, wherein a ratio of about 20:1 is most preferred.

Although the skilled person is familiar with the term “equivalent” in the field of polymer chemistry referred to here, for clarity purposes an explanation of what is meant by this is given here after. The term equivalent is understood in the usual sense, and focuses on the available reactive groups of molecules. For example, 1 mol of a monoalcohol contains 1 mol of OH groups; 1 mol of a diol contains 2 mol of OH groups, 1 mol of a triol contains three moles of OH groups, et cetera. Quite analogous, 1 mol of a diglycidyl ether (EpO functionality=2) contains 2 moles of glycidyl groups and thus oxirane groups.

If one, for example, wants to react a diglycidyl ether (A) and a compound (B) with one another such that the compounds used in relation to the oxirane rings and OH groups are available in a certain ratio, it is advisable to tune the ratios of the reactive groups instead of weight or molar ratios. This EpO (A):ZH (B) ratio is referred to as the equivalent ratio. Generally speaking, the equivalent ratio is expressed as the number ratio of specified reactive groups in the reactants used.

For clarity purposes it is illustrated by a practical example how to easily determine an equivalent ratio. For example, if one reacts in the context of the present invention
3 mol of bisphenol-A diglycidyl ether (epoxy functionality=2) with 2 oxirane groups per molecule, and
1 mol of a polyethylene glycol (OH functionality=2) with two OH groups per molecule with one another, then
The used bisphenol-A diglycidyl ether contains 6 mol oxirane groups, and
The used PEG contains 2 mol OH groups,

The number ratio of the oxirane groups of the bisphenol-A diglycidyl ethers to the OH groups of the polyethylene glycol therefore amounts to 6:2 or 3:1.

In step (ii), the compounds (A) and (C) are used in an equivalent ratio EpO (A):ZH (C) in the range from 1.1:1 to 20:1, preferably 1.1:1 to 10:1 and particularly 1.5:1 to 5:1. It is particularly preferred to use the compounds (A) and (C) in an equivalent ratio EpO (A):ZH (C) in the range of 1.5:1 to 3:1 and in particular 1.8:1 to 2.2:1, wherein a ratio of about 2:1 is most preferred. It should be noted explicitly that these specifications for the equivalent ratio in step (ii), regarding compounds (A), the total amount of the compounds (A) that is used in step (ii) is meant; compounds (A) which originate from the reaction mixture obtained at the end of the reaction step (i) contribute to this total amount equally well as compounds (A), which are, if necessary, further added after completion of the reaction (i) for dilution purposes, as well as compounds (A) that are added even further in step (ii). In other words, the total amount of compounds (A), which is used in step (ii) and is to be taken into account for said equivalent ratios (A):(C), is constituted by the residual content of (A) present at the end of stage (i) plus the amount of (A), which is, if necessary, further added after the completion of the reaction (i) for dilution purposes, plus the amount of (A) which is added even further in step (ii).

Step (ii) is preferably carried out at temperatures in the range 120° C. to 190° C., and especially 140° C. to 170° C., preferably in the presence of a catalyst.

The reaction of step (ii) is completed when the H-acidic groups of the compounds (C) are consumed, i.e. when they have reacted under ring opening of the oxirane groups present in the system. This is readily evident from the fact that the epoxide content of the mixture no longer decreases.

In an embodiment, step (iii), i.e. the acrylation, is carried out in an oxygen-containing atmosphere—particularly air—and in the presence of an inhibitor. For the remainder, any other techniques known to the person skilled in the art can be used regarding the acrylation.

In step (iv), the atmosphere is not critical. As far as the acrylation is carried out in an oxygen-containing atmosphere—particularly air—and in the presence of an inhibitor, one preferably sticks to the oxygen-containing atmosphere, in particular air, introduced at step (iii). The acrylation in step (iii) is carried out by means of acrylic acid and/or methacrylic acid. In a particularly preferred embodiment, only acrylic acid is used.

In step (iv), optionally, a viscosity-reducing additive can be added, because the phase inversion is usually accompanied by a significant increase in viscosity.

Appropriate viscosity reducing agents include in particular organic solvents with low molecular weight, in particular a molecular weight below 350. Such solvents have in addition to their viscosity-reducing function a hydrophilization effect on the organic phase and support the dispersion of the epoxy acrylate resin (P). Examples of suitable solvents include for instance ethoxypropanol, propoxypropanol or isopropanol. Optionally, these volatile organic solvents can be partially or completely removed again from the final dispersion, for example by evaporation in vacuum.

Optionally, also low-viscosity mono- or multi-functional acrylates can be used instead of organic solvents as viscosity-reducing agents.

The amount of viscosity-reducing additives, which are optionally added in step (iv), is at most 10 weight % and preferably at most 6.5 weight % (in each case based on the total dispersion).

Preferably, the preparation of the aqueous dispersion according to the present invention containing (a) epoxy acrylate resin (P*) and (b) dispersant (D*) is performed such that the dispersion has a solids content ranging from 10 to 70 weight %, especially 25 to 60 weight %, based on the total dispersion.

It is emphasized again that the multistage process control and the associated boundary conditions are crucial to the success of the present invention. Only by this particular combination of features, which is neither directly and unambiguously disclosed nor suggested in the cited WO 2006/056 331, the solution of the above problem statement will be achieved.

In particular, the epoxy acrylate dispersions according to WO 2006/056 331 exhibit an insufficient storage stability. For example, the dispersion according to Example 2 of WO 2006/056 331 A1 has only short-term (less than 10 days) storage stability at 25° C. and therefor does not meet the object of the present invention, whereby a storage stability of epoxy acrylate dispersions of at least 3 months at 25° C. is required. Moreover, the storage stability correlates according to studies by the applicant with the phase inversion temperature which temperature is important for step (iv). This temperature can thus be considered as an indicator that the composition of the dispersions according to the present invention and according to WO 2006/056331 are different. Thus, one can for instance deduct from the section Examples, that the dispersion according to the present invention (Example 1) has a phase inversion temperature of 60° C., whereas in the comparative example (Example 2) the phase inversion temperature is only 30° C. This correlates with an exceptionally good storage stability of the dispersion of Example 1 (more than 6 months) and a very poor storage stability of the dispersion of Example 2 (less than 10 days).

That the epoxy acrylate composition of the present invention and those according to the teachings of WO 2006/056 331, wherein according to the examples a one-pot reaction is performed, are different, is characterized also clearly in the very different properties of the dispersions, in addition to the already mentioned difference regarding the phase inversion temperature.

In this respect, reference is made to the section Examples of the present application, where it is demonstrated that the teachings of the present invention as compared to the teachings of WO 2006/056 331 lead to the following advantages:
abrupt and extremely strong increase of the storage stability of the dispersion
abrupt and extremely strong increase in the hardness of coatings based on epoxy acrylate dispersions after physical drying and prior to UV curing.

### Regarding Compounds (A)

The compounds (A) are selected from the group of nonionic compounds having an HLB value of less than 12 and having per molecule at least two oxirane groups.

The oxirane groups in the compounds (A) may, as regards their position, be terminal (at the end of the chain) or be arranged internal. Preferably, the oxirane groups are terminal.

In an embodiment those compounds (A) are chosen that are obtainable by epoxidation of corresponding compounds which contain at least two C═C double bonds.

In one embodiment, the compounds (A) are selected from the group consisting of glycidyl compounds having a functionality of at least 2. These are compounds having per molecule two or more glycidyl groups, i.e. groups which are characterized by the following formula:

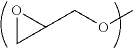

The reactive group within the glycidyl group is the oxirane ring (EpO). Two particularly attractive glycidyl compounds within the scope of the present invention are:
Glycidyl ethers, which are typically prepared by reacting polyols with epichlorohydrin.
Glycidyl esters, which are for example obtainable by reacting polycarboxylic acids with epichlorohydrin.

The glycidyl groups in the compounds (A) may be arranged terminally or internally with respect to their position. Preferably, the glycidyl groups are terminal.

Preferably, glycidyl ether is used as glycidyl compound (A), in particular aliphatic, cycloaliphatic or aromatic epoxy compounds or mixtures thereof.

Examples of suitable polyfunctional glycidyl ethers having a functionality ≧2 are: bisphenol-A diglycidyl ether, fully hydrogenated bisphenol-A diglycidyl ether, bisphenol-F diglycidyl ether, bisphenol-A/F diglycidyl ether, epoxy Novolac resins, Cardanol® NC 514 (cardanol-based diglycidyl ether of Cardolite), castor oil triglycidylether, ethylene glycol diglycidyl ether, 1,4-butanediol diglycidyl ether, 1,6-hexanediol diglycidyl ether, 1,4-cyclohexanedimethanol diglycidyl ether, neopentyl glycol diglycidyl ether, trimethylolpropane triglycidyl ether, trimethylolethane triglycidylether, propoxylated glycerol triglycidyl ether, glycerol triglycidyl ether and pentaerythritol tetraglycidyl ether.

Examples of suitable polyfunctional glycidyl esters having a functionality ≧2 are: dimer fatty acid diglycidyl esters, hexahydrophthalic acid diglycidyl esters.

Examples of suitable polyfunctional epoxides having a functionality ≧2 are: epoxidized soybean oil, epoxidized linseed oil, epoxidized linseed oil fatty acid methyl esters, limonene dioxide, 3,4-epoxycyclohexylmethyl-3,4-epoxycyclohexane carboxylate, bis-(3,4-epoxycyclohexylmethyl) adipate.

In an embodiment, difunctional glycidyl ethers are used, i.e. compounds with two glycidyl ether groups per molecule.

In a preferred embodiment, bisphenol-A diglycidyl ether is used as compound (A).

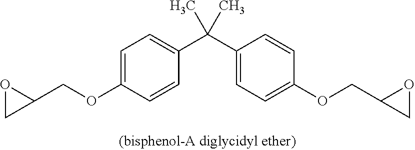 [SMILES: CC(C)(c1ccc(OCC2CO2)cc1)c1ccc(OCC2CO2)cc1]

The compounds (A) are different from the compounds (B) and from the compounds (C).

In an embodiment, the compounds (A) comprise in addition to the compulsory oxirane groups one or more acrylate groups per molecule.

### Regarding Compounds (B)

The compounds (B) are selected from the group of nonionic compounds having an HLB value in the range of 12 to 20 and having per molecule at least one H-acidic group (ZH). Preferably, the HLB value of the compounds (B) is in the range of 15 to 20.

The compounds (B) are free of oxirane groups.

The H-acidic group in the context of the present invention—for compounds (B) as well as for compounds (C)— is understood to be a group that contains a Zerewitinoff-active hydrogen atom. As is generally known, a N, O or S bonded hydrogen is referred to as a Zerewitinoff-active hydrogen (sometimes abbreviated to “active hydrogen”), if said hydrogen, according to a process discovered by Zerewitinoff, delivers methane when it reacts with methyl magnesium iodide. Typical examples of compounds having Zerewitinoff-active hydrogen are compounds which contain carboxyl, hydroxyl, amino, imino or thiol groups as functional groups. In the context of the present invention it is of crucial importance that the H-acidic groups (ZH) can react with oxirane rings (EpO) under ring opening. In the context of the present invention, OH groups, SH groups, COOH groups as well as primary or secondary amine groups are especially preferred as H-acidic groups of the compounds (B).

In contrast to the compounds (C), which are hydrophobic in nature, the compounds (B) are hydrophilic substances.

The H-acidic groups in the compounds (B) can be arranged terminally or internally with respect to their position.

The H-acid groups are preferably terminal. Compounds (B) having two H-acidic groups are preferred.

It should be clarified that the compounds (B) are structurally different from the compounds (C). The difference is that the compounds (C) are free of hydrophilic structural elements, which elements determine the relatively high HLB values of the compounds (B). For the compounds (B), hydrophilic structural elements (for example polyalkylene oxide building blocks or sugar building blocks, polyalkylene oxide blocks being preferred) are essential, since they account for the water-compatibility, or rather water-solubility, of the dispersants according to the present invention. Accordingly, the hydrophilic structural elements in the compounds (B) must be present to such extent that the compounds obtained therefrom by reaction with compounds (A) together with subsequent acrylation are dispersants for the epoxy acrylates.

In an embodiment, the cloud point of the compounds (B) is above 50° C. The cloud point of a nonionic compound is the temperature at which an aqueous solution of this compound starts separating into two phases, an aqueous one and one containing the non-ionic compound, and therefore gets cloudy. The cloud point in the context of the present invention is determined by the method according to DIN EN 1890.

Examples of suitable nonionic compounds (B) with H-acidic groups and having and an HLB value above 12 are for instance:
Polyethylene glycols,
EO/PO-block copolymers such as Jeffamine® M-1000 and Jeffamine® M-2070 from Huntsman, Tetronic® 304, Tetronic® 904, Tetronic® 908, Tetronic® 1107 and Tetronic® 1307 from BASF and Synperonic® T/707 and Synperonic® T/908 from Croda,
PO/EO/PO-block copolymers such as Jeffamine® ED-2003 from Huntsman and Pluronic® 10R5 and Pluronic® 10R5 from BASF,
EO/PO/EO-block copolymers such as Pluronic® F38, Pluronic® F68, Pluronic® F77, Pluronic® F87, Pluronic® F88, Pluronic® F98, Pluronic® F108, Pluronic® F127, Pluronic® P65, Pluronic® P84, Pluronic® P85, Pluronic® P104, Pluronic® P105, Pluronic® L35, Pluronic® L44 and Pluronic® L64 from BASF and the equivalent products from the Synperonic® PE range from Croda,
Polyoxyethylene sorbitan esters such as Tween® 20, Tween® 21, Tween® 40, Tween® 60 and Tween® 80 from Croda,
Polyoxyethylene alcohols such as Brij® L23, Brij® S10, Brij® S20, Brij® S721, Brij® S100, Brij® 020, Brij® C10, Brij® C20, Synperonic® 13/9, Synperonic® 13/10, Synperonic® 13/12 and Synperonic® A20 from Croda,
Polyoxyethylene fatty acid esters such as polyoxyethylene Myrj® S40, Myrj® S50 and Myrj® S100 from Croda,
Polyoxyethylene alkylamines like Atlas® 3789, Atlas® G-3780A, Crodamet® C-15 and Crodamet® T-15 from Croda,
Reaction products of hydroxyl-containing compounds with alkylene oxides and compounds which are obtainable by exchanging the terminal hydroxyl groups of reaction products of hydroxyl-containing compounds having alkylene oxides with amino groups.

Regarding the reaction of hydroxyl-containing compounds with alkylene oxides, ethoxylation and propoxylation are of particular importance. This is normally carried out as follows: In a first step, the desired hydroxyl-containing compounds are exposed to ethylene oxide and/or propylene oxide and this mixture is converted in the presence of an alkaline catalyst at temperatures in the range 20-200° C. In this way, addition products of ethylene oxide (EO) and/or propylene oxide (PO) are obtained. The addition products preferably are EO adducts or PO adducts or EO/PO adducts to the relevant hydroxyl-containing compound; the addition of EO and PO within the EO/PO adducts can occur randomly or blockwise.

In an embodiment, the compounds (B) are selected from the group of nonionic compounds having on the one hand per molecule on average 5 to 300 alkylene oxide building blocks and on the other hand at least two H-acidic groups, wherein the compounds (B) contain on average per molecule more ethylene oxide units than the sum of all other alkylene oxide units, and the compounds (B) on average contain at least 5 ethylene oxide units per molecule. Compounds that come into question as the alkylene oxide building blocks preferably are ethylene oxide (EO), propylene oxide (PO) and butylene oxide (BuO). Here the above-mentioned boundary conditions apply, according to which the compounds (B)
contain on average per molecule more ethylene oxide units than the sum of all other alkylene oxide units, and
contain on average at least 5 ethylene oxide units per molecule.

Preferably, the compounds (B) contains on average per molecule 20 to 300 and especially 50 to 250 EO units.

In an embodiment, the compounds (B) are selected from the group of EO/PO-block copolymers with terminal hydroxyl groups and the EO/PO-block copolymers with terminal primary or secondary amine groups; in this respect those types having their HLB value in the range of 15 to 20 are particularly preferable.

Examples of suitable EO/PO-block copolymers having two or more terminal hydroxyl groups and EO/PO-block copolymers having at least one terminal primary or secondary amine group are the Pluronic® F—, Pluronic® P- and Pluronic® L-types from BASF, the Synperonic® PE types from Croda as well as the Jeffamine® M- and Jeffamine® ED types of Huntsman.

In a further embodiment, the compounds (B) are selected from the group of nonionic compounds containing sugar building blocks as hydrophilic groups. In this respect, the group of Tweens, polyoxyethylene sorbitan esters, the sugar building block of which is a dehydration product of sorbitol, a sugar alcohol, are preferred.

In an embodiment, the compounds (B) are selected from the group of substances of the general structure R¹—O—R²—CH₂CH(R³)—X. In this formula:
R¹ is a monovalent organic group having 1-12 carbon atoms which may be aliphatic, cycloaliphatic or aromatic,
R² is a polyoxyalkylene group built of 5-200 polyoxyalkylene units, especially EO and/or PO units,
R³ is hydrogen or an aliphatic radical having up to 4 carbon atoms,
X is an OH or NH₂ group.

In this respect, the above-mentioned boundary conditions apply, according to which the compounds (B) contain on average per molecule more ethylene oxide units than the sum of all other alkylene oxide units and contain on average at least 5 ethylene oxide units per molecule. In an embodiment, the compounds (B) are selected from the group of adducts of EO and/or PO with fatty alcohols having from 1 to 18 carbon atoms.

### Regarding Compounds (C)

The compounds (C) are selected from the group of nonionic compounds having an HLB value of less than 12 and having per molecule at least two H-acidic groups (=having a functionality ≧2). The compounds (C) are free of oxirane groups. The H-acidic groups in the compounds (C) may, regarding their position, be terminal or be arranged in the molecule. The H-acidic groups are preferably terminal. Compounds (C) having two H-acidic groups are preferred.

In contrast to the compounds (B), which are hydrophilic in nature, the compounds (C) are hydrophobic substances.

Preferably, the HLB values of the compounds (C) are below 10.

Preferably, the compounds (C) neither contain polyalkylenoxide building blocks nor sugar building blocks.

The compounds (C) can, from a synthetic point of view, be characterized as chain extender.

H-acidic groups—as already argued above for compounds (B)—are understood to be functional groups which can react with oxirane rings under ring opening. In the context of the present invention, OH groups, SiOH groups, SH groups as well as COOH groups are especially preferred as H-acidic groups of the compounds (C).

Suitable polyols having a functionality ≧2 are: bisphenol-A, hydrogenated bisphenol-A, bisphenol-F, 1,4-butanediol, 1,6-hexanediol, 1,8-octanediol, 1,10-decanediol, 1,12-dodecanediol, dimer diol, trimethylolpropane, pentaerythritol, isosorbide, diethylene glycol, triethylene glycol, tetraethylene glycol, dipropylene glycol, tripropylene glycol, block copolymers of ethylene glycol and propylene glycol, 1,4-cyclohexanedimethanol and 1,6-cyclohexanediol.

Suitable thiols having a functionality ≧2 are: ethylene glycol di-3-mercaptoproprionate, ethylene glycol di-2-mercaptoacetate, hexanedithiol, trimethylolpropane tri-(2-mercaptoacetate), trimethylolpropane tri-(3-mercaptoproprionate), pentaerythritol tetra-(2-mercaptoacetate) and pentaerythritol tetra-(3-mercaptoproprionate).

Suitable hydroxy-functional polysiloxanes having a functionality ≧2 are: Dow Corning® 3-0133, Dow Corning® 3-0213, Dow Corning® 3-0113, Dow Corning® 3-0084, Dow Corning® 2-1273 and Dow Corning® 4-2737 from Dow Corning.

In an embodiment, polyols are used as compounds (C). Diols are preferred, especially those with terminal OH groups.

In a preferred embodiment bisphenol-A is used as compound (C).

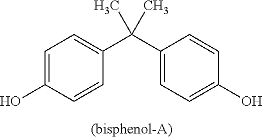 [SMILES: CC(C)(c1ccc(O)cc1)c1ccc(O)cc1]

### Catalysts

In steps (i) to (iii), in each step, a catalyst may be used. Preferably, in step (i) a catalyst is mandatory.

Examples of suitable catalysts in step (i) are boron trifluoride-amine complexes and alkali metal alcoholates.

Examples of suitable catalysts in step (ii) are triphenylphosphine and ethyltriphenylphosphonium iodide.

Examples of suitable catalysts in step (iii) are triphenylphosphine, thiodiglycol, dimethyl sulfide, diethyl sulfide, triethylamine, N,N-dimethylaniline and N,N-dibenzylmethylamine.

### Inhibitors

In step (iii), an acrylation is performed. This can, in principle be performed using all relevant acrylation techniques known to the person skilled in the art. In an embodiment, acrylations are carried out—optionally in the presence of a catalyst—in the presence of an inhibitor and in an oxygen-containing atmosphere, for example air. Examples of suitable inhibitors are 4-methoxyphenol, phenothiazine, hydroquinone, 2,6-di-tert-butyl-4-methylphenol, 2-tert-butyl-4-hydroxyanisole, triphenyl phosphite and dinitrobenzene.

### Use

The dispersions according to the present invention are characterized by good workability and applicability (=incorporation into useful systems from a technical application point of view) and are suitable for coating various substrates, particularly wood, plastics, metals, paper, cardboard, glass, ceramics, leather, textiles by spraying, pouring, rolling, smearing, knife coating and immersing.

Optionally, further usual coating additives may be added to the dispersions according to the invention such as photoinitiators, defoamers, de-aerating agents, leveling agents, UV absorbers and light stabilizers, pigments, dyes, fillers, rheology additives, waxes, matting agents, dispersants, biocides, and coalescence agents.

A further aspect of the invention is therefore the use of the aqueous dispersions of epoxy acrylates obtainable as described above as radiation-curable compositions for coating systems such as pigmented and unpigmented lacquers and coating compositions as well as paints and the like.

More particularly, the aqueous dispersions of the epoxy acrylates are suitable for coating wood, both as a primer and as a topcoat. In general, excellent adhesion is found on wood. As a topcoat, they are moreover characterized by very high gloss and excellent chemical resistance (e.g., against acetic acid, ammonia and ethanol) and further by good scratch and abrasion resistance.

### Process

A further aspect of the invention is a method for preparing aqueous radiation-curable epoxy acrylate dispersions containing (a) an epoxy acrylate resin (P*) having at least 2 acrylate groups per molecule, said epoxy acrylate resin being not self-dispersing in water at 25° C., and (b) a dispersant (D*) having at least one acrylate group per molecule, wherein

in a first step (i)
one or more compounds (A), which are selected from the group of nonionic compounds having an HLB value of less than 12 and having at least two oxirane groups per molecule, are reacted with
one or more compounds (B), which are selected from the group of nonionic compounds having an HLB value ranging from 12 to 20 and having per molecule at least one H-acidic group (ZH)

optionally in the presence of a catalyst—in which process the compounds (A) and (B) are applied in an equivalent ratio EpO (A):ZH (B) in the range of 1.3:1 to 400:1,

the obtained reaction mixture, in a second step (ii)
is reacted with one or more nonionic compounds having an HLB value of less than 12 and having per molecule at least two oxirane groups (compounds A), and
with one or more compounds (C), which are selected from the group of nonionic compounds having an HLB value of less than 12, and having per molecule at least two H-acidic groups,

optionally in the presence of a catalyst—in which process the compounds (A) and (C) are applied in an equivalent ratio EpO (A):ZH (C) in the range of 1.1:1 to 20:1,

the obtained reaction mixture, in a third step (iii)

optionally in the presence of a catalyst—is reacted with acrylic acid under ring opening of all epoxy groups,

the obtained reaction mixture, in a fourth step (iv)
is dispersed in water.

### EXAMPLES

### 1. Substances Used

Pluronic® F 88—difunctional EO/PO/EO-block copolymer having terminal hydroxyl groups, molecular weight of approximately 11000, from BASF
D.E.R.™ 331™—bisphenol-A diglycidyl ether, from Dow Chemical
Anchor® 1040 Curing Agent—modified amine complex of boron trifluoride, from Air Products
Bisphenol-A—from Bayer MaterialScience
Triphenylphosphine—from Arkema
4-Methoxyphenol—from Acros Organics
Acrylic acid—stabilized with 200 ppm 4-methoxyphenol, from BASF
Ethoxypropanol—from Brenntag
Chem® E Res 20—bisphenol-A diglycidyl ether, from Cognis
WUQ—condensation product of propoxylated pentaerythritol (5 PO units on average) with epichlorohydrin, from Cognis
Jeffamine® M-2070—mono-functional EO/PO-block copolymer with terminal amine groups, molecular weight about 2000, from Huntsmann
PU-acrylate dispersion—Bayhydrol® UV 2282, a radiation-curable ionic polyurethane acrylate dispersion from Bayer MaterialScience, with 39% solids and a pH-value of 7,4. Was used as the reference product for the characterization of material properties of the example according to the invention (see data section below, section No. 3)

### 2. Measuring and Test Methods

Acid number: according to NF EN ISO 660
Viscosity: determined at 25° C. according to ISO 3219

All viscosities were measured at a shear rate of 40 sec⁻¹ on a Bohlin C-VOR rheometer from Malvern Instruments.

### Epoxide Content

To characterize the content of compounds having oxirane groups (“epoxy groups”), an epoxide titration was performed. The epoxy number (% EpO) obtained therefrom indicates how many grams of oxirane oxygen are contained in 100 grams of a sample.

This titration is based on the following principle: A solution having an excess of tetraethylammonium bromide is added to the sample containing oxirane rings. The mixture is then titrated with a solution of perchloric acid in glacial acetic acid, which releases an equimolar amount of hydrogen bromide. The hydrogen bromide reacts under ring opening with the oxirane rings to form the corresponding bromohydrin.

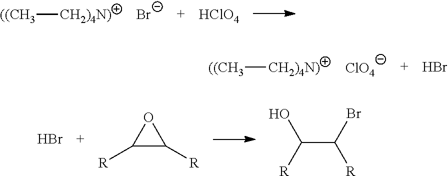

The indicator used is crystal violet. This determination presupposes the absence of water, bases and amines.

The Following Reagents were Used:

(1) 0.1 N-perchloric acid (Merck) in glacial acetic acid; (2) tetraethylammonium bromide (Fluka) in the form of a solution of 100 g tetraethylammonium bromide in 400 ml of glacial acetic acid; (3) crystal violet (Merck); in order to prepare the indicator solution, 0.2 g of crystal violet was dissolved in 100 ml of glacial acetic acid.

Implementation:

0.2 to 0.5 g of the sample containing the oxirane rings is placed in an Erlenmeyer flask. The sample is dissolved in 50 ml of anhydrous acetone. Then, 10 ml of tetraethyl ammonium bromide solution (see above) and 3 drops of crystal violet solution (see above) are added. The mixture is titrated with a 0.1-N solution of perchloric acid in glacial acetic acid. The end point is reached when the color changes from blue to green. Prior to performing the actual titration, a blank test (no oxirane compound) is carried out in order to exclude measurement errors.

Evaluation:

The epoxide content % EpO is calculated as follows:

% EpO=[(a−b)×0.160]/E

a:=milliliters of 0.1 n HClO₄ solution, required for titration
b:=milliliters of 0.1 n HClO₄ solution, required in the blank test
E:=weight of sample in grams

### Epoxide Equivalent Weight

The epoxide equivalent weight (EEW) can be calculated from the epoxide number (see above) as follows:

EEW=16×100% EpO

The dimension of the EEW is g/eq.

### Phase Inversion Temperature

A sample of each dispersion was taken from the reactor at a given temperature and a drop was rubbed of a glass rod into a beaker with approximately 300 to 400 ml of water. A rapid as well as a complete distribution of the dispersion droplet in water indicates the presence of an O/W dispersion, and thus the relevant phase inversion temperature. If the droplet does not distribute at all, a W/O dispersion exists and the phase inversion temperature has not yet been reached.

pH-value: at 25.0° C. according to ISO 976
Solids content: according to ISO 3251
2 g of the dispersion to be tested were dried for 60 minutes at 125° C. in a convection oven.

### Particle Size Distribution

The particle size distribution curves were determined using dynamic light scattering at 25.0° C. with a Mastersizer Hydro 2000M from Malvern Instruments.

### Storage Stability

The test dispersions were stored in a sealed glass vessel at a given temperature and were examined after the end of the storage time on changes in particle size and distribution, viscosity, phase separation and settling.

### Sample Preparation

All laboratory tests for UV curing were performed under air using a UV belt dryer of the type M-40-2xl-R-TR-SLC-SO-inert from the company IST Metz, which was equipped with a 200 Watt/cm medium pressure mercury lamp. The resulting energy density was determined using a UV Power Puck from EIT by summing the respective UV-A (320-390 nm), UV-B (280-320 nm), UV-C (250-260 nm) and UV-V (395-445 nm) energy densities. All material-related and application-related characteristics were determined based on mixtures of 99 weight % of the relevant dispersion and 1 weight % of the photoinitiator Irgacure® 184 from Ciba. Corresponding films were prepared with the desired layer thickness by knife coating on each substrate, then physically dried at 50° C. for 10 minutes in a convection oven to remove water, and subsequently completely UV cured at an energy density of 1500 mJ/cm². All films were equilibrated at 25° C. for 24 hours before each measurement.

Pendulum hardness: according to Persoz (ISO 1522)

To determine the pendulum hardness, films with a wet film thickness of 150 μm on QD-36 cold rolled steel sheets from the firm Q-Lab were produced and measured after the above-described sample preparation, including UV-curing.

Gloss: according to ISO 2813

To determine the gloss, films with a wet film thickness of 12 μm and 150 μm on Form 2A Opacity Charts from the company Leneta were made and were measured after the above described sample preparation, including UV-curing, with the micro-gloss 60° gloss meter from the company BYK-Gardner.

Chemical resistance: according to DIN 68861-1

The chemical resistance was determined on beech substrates, which were first pretreated with abrasive paper with a P 180 alumina grit, then coated with a wet film having a thickness of 150 μm using the relevant mixture of dispersion and photoinitiator, dried physically and subsequently UV cured. After polishing this first layer with abrasive paper with a P 320 aluminum oxide grit, a second layer of the same mixture of dispersion and photoinitiator with a wet film thickness of 150 μm was applied, physically dried and finally UV cured. The chemical resistance was then determined according to DIN 68861-1, after the coated samples had been stored for conditioning for 1 week at 25° C.

Adhesion to metal: according to ISO 2409

To determine the adhesion on metal, first films were produced with a wet film thickness of 150 μm on QD-36 cold rolled steel sheets, on S-36-I iron phosphated steel sheets, on A-36 aluminum sheets and on ALQ-36 chromated aluminum sheets from the company Q-Lab. After the above described sample preparation, including UV-curing, the adhesion was determined using cross-cut tests with Scotch® Crystal Clear tape from the company 3M.

### 3. Examples

### Example 1

### According to the Invention

### Step (i):

14.852 kg of Pluronic® F 88 and 10.043 kg D.E.R.™ 331™ were charged into a heatable reactor under nitrogen atmosphere and heated to 100° C. under slow stirring until a clear melt is obtained. Then, 0.11 kg of catalyst Anchor® 1040 Curing Agent were added and heated up to 140° C. The reaction started immediately, with low exothermicity. Upon reaching the reaction temperature of 140° C., as well as every subsequent hour during the progress of the reaction, a sample was taken for determination of the epoxide content. After reaching the desired epoxide content (after about 5 hours) in the range of 2.86 to 2.96% EpO, immediate cooling was started, and at 90° C. 24.995 kg D.E.R.™ 331™ were added, purely for dilution purposes. The yellowish viscous, slightly cloudy final product was filtered through a coarse filter bag at 60° C., because the product starts crystallizing at 40° C. and is solid at room temperature. The final product had a viscosity of 3500 mPas at 40° C. and the epoxide equivalent weight (EEW) was 286 g/eq.

### Step (ii):

37.51 kg D.E.R.™ 331™, 13,75 kg of the product from step (i), 14.02 kg of bisphenol-A and 0.078 kg of the catalyst triphenylphosphine were charged into a heatable reactor under a nitrogen atmosphere and homogenized under stirring. The contents of the reactor were then heated up to 140° C., whereby the exothermicity of the reaction heated the reactor contents to about 160° C. After passing through the exothermicity, the reactor contents were kept for 0.5 h at 160° C.

Subsequently, a sample was taken for the determination of the epoxide content; as soon as this content was in the range of 2.80-3.20% % EpO, the reactor contents were cooled to 90-95° C. Upon reaching 100° C., 0.19 kg of the inhibitor 4-methoxyphenol were added and the introduction of air into the reaction mixture was started.

Step (iii):

0.37 kg of the catalyst triphenylphosphine were dissolved in 9.06 kg of acrylic acid and half of this solution, after reaching the target temperature of the reactor contents of 90 to 95° C., was added slowly within 10 minutes using a dosing system. After 2 h reaction time at 90-95° C., the other half was added in the same way. Stirring of the reactor contents was continued at 90 to 95° C. until the epoxide content was decreased below 0.2% EpO, whereby the acid value must not fall below 1 mg KOH/g, which lasted about 10-15 hours.

### Step (iv):

Subsequently, 9.3 kg ethoxypropanol were slowly added under stirring at 85° C., the mixture was stirred 0.5 h further and 11.36 kg of deionized water were added quickly. This formed a homogeneous W/O dispersion and the temperature of the reactor contents dropped to 75° C. The reactor contents were then further cooled to 55° C. When the temperature decreased, an O/W dispersion appeared through a phase inversion, which was accompanied by a sharp increase in viscosity. The phase inversion temperature was 60° C. After reaching 55° C., stirring was continued for 0.5 h. Then, 17.95 kg of deionized water were added slowly over a period of 1 h, whereby the viscosity decreased strongly. Afterwards, in another hour, 35.91 kg of deionized water were added, which was stirred for another 1 h. Subsequently, the resulting epoxy acrylate dispersion was filtered through a DS 900 filter from SeitzSchenck.

The final product had a viscosity of 148 mPa at 25° C. and a pH-value of 6.51. Moreover, it demonstrated a solids content of 49.0 weight % and a mean particle size D₅₀ of 425 nm.

### Example 2

### Comparative Example

For comparative purposes, an epoxy acrylate dispersion according to WO 2006/056331 was prepared, namely as follows:

30.00 kg Chem® Res E 20 and 0.046 kg WUQ were charged into a heatable reactor under a nitrogen atmosphere and were homogenized under stirring. Subsequently, 7.35 kg Jeffamine® M-2070, 7.70 kg of bisphenol-A and 0.033 kg of the catalyst triphenylphosphine were added and the reactor contents were heated up to 150° C., whereby the exothermicity of the reaction heated the reactor contents up to about 165 to 170° C. After passing through the exothermicity, the reactor contents were kept for 0.5 h at 165-170° C. Thereafter, a sample was taken to determine the epoxide content. As soon as this value reached 2.80 to 3.20% EpO, the reactor contents were cooled to 85-90° C. At 85 to 90° C., 0.13 kg of the inhibitor 4-methoxyphenol was added and the introduction of air was started. Within 0.5 h, at 85 to 90° C., a mixture of 0.37 kg of catalyst triphenylphosphine and 9.55 kg of acrylic acid were slowly added using a dosing system. The reactor contents were stirred at 90 to 95° C. until the epoxide content decreased below 0.2% EpO, whereby the acid value must not fall below 1 mg KOH/g, which lasted about 10-16 h, then 6.47 kg of ethoxypropanol were added.

After cooling to 80° C., 8.87 kg of deionized water were added, which lowered the viscosity of the mixture. When the temperature decreased, an O/W dispersion appeared through a phase inversion, which was accompanied by a sharp increase in viscosity. The phase inversion temperature was 30° C. Then, stirring was continued for 0.5 h at 30° C. Subsequently, 36.76 kg of deionized water were added. The resulting epoxy acrylate dispersion was filtered through a DS 900 filter from SeitzSchenck.

The final product had a viscosity of 450 mPa·s at 25° C., a pH-value of 5.7, a solids content of 50.5 weight % and a mean particle size D₅₀ of 550 nm. Properties and Applications

Phase inversion temperature

| | Phase inversion temperature |
|---|---|
| Example 1 (according to the invention) | 60° C. |
| Example 2 (comparative example) | 30° C. |

The example according to the present invention shows a significantly higher phase inversion temperature than the comparative example (not according to the invention), which is directly correlated to the storage stability. While the example according to the present invention has an excellent and practice-oriented storage stability of at least 6 months, the value of the comparative example is less than 10 days, which is totally inadequate for industrial applicability. The poor storage stability of the comparative example was expressed in a visually clear phase separation.

Storage stability

| | Storage stability at 25° C. | | | | | |
|---|---|---|---|---|---|---|
| | 1 day | 10 days | 28 days | 2 months | 4 months | 6 months |
| Example 1 | stable | stable | stable | stable | stable | stable |
| (according | | | | | | |
| to the | | | | | | |
| invention) | | | | | | |
| Example 2 | stable | un- | un- | un- | un- | un- |
| (compar- | | stable | stable | stable | stable | stable |
| ative | | | | | | |
| example) | | | | | | |

The determination of the pendulum hardness after physical drying and prior to UV-curing for the example according to the present invention already resulted in an tack-free film, which does not yet have the mechanical and chemical resistance of the UV-cured film, but has a mechanical stability that allows for easy and immediate further processing on coating systems. In contrast, the comparative example (not according to the present invention) provided after physical drying and prior to UV curing such a sticky film that a pendulum hardness measurement was not possible, which excluded a fast further processing on coating systems. The pendulum hardness attainable after physical drying and UV curing are at a similar level, although the example according to the present invention has a small advantage here.

Pendulum hardness according to Persoz

| | Pendulum hardness according to Persoz | |
|---|---|---|
| | After physical drying, | After physical drying, |
| | prior to UV curing | and UV curing |
| Example 1 (according to | 53 sec | 268 sec |
| the invention) | | |
| Example 2 (comparative | <5 sec | 259 sec |
| example) | | |

The superiority of the dispersion according to the present invention with regard to the pendulum hardness after physical drying and prior to UV curing compared to the comparative dispersion is orders of magnitude better.

The following data illustrate this: regarding the application-related properties of pendulum hardness and gloss, the nonionic dispersion according to the present invention exceeds the ionic polyurethane acrylate dispersion, which is relied on as the commercially available standard, with regard to all evaluation criteria.

Pendulum hardness according to Persoz

| | Pendulum hardness according to Persoz | |
|---|---|---|
| | After physical drying, | After physical drying, |
| | prior to UV curing | and UV curing |
| Example 1 (according to | 53 sec | 268 sec |
| the invention) | | |
| PU acrylate dispersion | 26 sec | 247 sec |

Gloss

| | Gloss | |
|---|---|---|
| | Example 1 (according | PU acrylate |
| | to the invention) | dispersion |
| Wet film thickness of 12 μm | 101 | 87 |
| Wet film thickness of 150 μm | 99 | 89 |

Chemical resistance

| | | | Example 1 | PU |
|---|---|---|---|---|
| | Exposure | | (according to | acrylate |
| | time | | the invention) | dispersion |
| Acetic acid solution, 10 weight | 1 | h | 0 | 0 |
| % | | | | |
| Ammonia solution, 10 weight % | 2 | min | 0 | 0 |
| Aqueous ethanol solution, 48 | 1 | h | 0 | 0 |
| vol. % | | | | |
| Red wine | 6 | h | 0 | 0 |
| Coffee | 16 | h | 0 | 0 |
| Condensed milk, 10% fat | 16 | h | 0 | 0 |
| Deionized water | 16 | h | 0 | 0 |
| Ethyl acetate:butyl acetate, 1:1 | 10 | sec | 0 | 0 |
| (vol. %) | | | | |
| Butter | 16 | h | 0 | 0 |
| Olive oil | 16 | h | 0 | 0 |
| Mustard | 6 | h | 0 | 0 |

In wood coating for high-quality furniture surfaces, the resistance to chemicals is defined in standard DIN 68861-1, where it is stated that for demanding applications the level of 1 B is to be reached, which level corresponds to the specific exposure times mentioned in the preceding table for certain chemicals. The ratings range from 5=strong optically visible changes of the coated surfaces or damage, to the level 0=no visual change in appearance of the coated surfaces. The PU acrylate dispersion is in the wood coatings market known to reach the high level of 1 B. With the dispersion according to the present invention, the same excellent chemical resistance can be achieved as well, which is essential in the wood coatings industry.

Adhesion to metal

| | Example 1 (according | | | | | |
|---|---|---|---|---|---|---|
| | to the invention) | | | PU acrylate dispersion | | |
| | imme- | after | after | imme- | after | after |
| | diate | 24 h | 72 h | diate | 24 h | 72 h |
| Cold rolled | 0 | 0 | 0 | 4 | 2 | 0 |
| steel | | | | | | |
| Iron phosphated | 0 | 0 | 0 | 2 | 0 | 0 |
| steel | | | | | | |
| Aluminum | 0 | 0 | 0 | 4 | 2 | 0 |
| Chromated | 0 | 0 | 0 | 0 | 0 | 0 |
| aluminum | | | | | | |

Generally speaking, a practice-oriented adhesion to metal surfaces of radiation-curable binder systems can hardly be realized without the use of special additives. A suitable criterion for determining the adhesion is the cross-cut test, the rating level of which reaches from 5=more than 65% film peeling at the edges of the cross-cuts, to level 0=no film peeling at the edges of the cross-cuts. While the polyurethane acrylate dispersion and the dispersion according to the present invention show a very good adhesion directly after the UV curing on various aluminum and steel substrates optimized for adhesion, excellent and immediate adhesion to aluminum and steel substrates which have not been pretreated can only be observed for the dispersion according to the present invention. The adhesion of the polyurethane acrylate dispersion develops only over a period of several days, so that in this case immediate further processing is not possible.

1. An aqueous radiation-curable epoxy acrylate dispersion comprising:
(a) an epoxy acrylate resin (P*) having at least 2 acrylate groups per molecule, said epoxy acrylate resin being not self-dispersing in water at 25° C., and
(b) a dispersant (D*) having at least one acrylate group per molecule, which dispersion is obtainable by the steps of:
(i) reacting one or more nonionic compounds (A), which are have an HLB value of less than 12 and at least two oxirane groups per molecule, with one or more nonionic compounds (B), which have an HLB value in the range of 12 to 20 and at least one H-acidic group (ZH) per molecule—optionally in the presence of a catalyst—wherein the compounds (A) and (B) are present such that an equivalent ratio of EpO (A):ZH (B) is in a range of 1.3 to 400, to obtain a first reaction mixture;
(ii) reacting the first reaction mixture obtained in step (i), with one or more of said compounds (A) and with one or more nonionic compounds (C), which have an HLB value of less than 12 and at least two H-acidic groups (ZH) per molecule—optionally in the presence of a catalyst—wherein the compounds (A) (C) are present such that in an equivalent ratio of EpO (A):ZH (C) is in a range of 1.1 to 20, to obtain a second reaction mixture;
(iii) reacting the second reaction mixture obtained in step (ii) with acrylic acid optionally in the presence of a catalyst—under conditions of ring opening of all epoxy groups, to obtain a third reaction mixture; and
(iv) dispersing the third reaction mixture obtained in step (iii) in water.

2. The epoxy acrylate dispersion according to claim 1, wherein the compounds (A) are glycidyl ethers which comprise two or more glycidyl groups per molecule.

3. The epoxy acrylate dispersion according to claim 2, wherein compound (A) is bisphenol-A diglycidyl ether.

4. The epoxy acrylate dispersion according to claim 1, wherein the compounds (B) are selected from the group of consisting of polyethylene glycols, EO/PO-block copolymers, PO/EO/PO-block copolymers and EO/PO/EO-block copolymers.

5. The epoxy acrylate dispersion according to claim 1, wherein the compounds (C) are polyols having two or more OH groups per molecule.

6. The epoxy acrylate dispersion according to claim 5, wherein the compound (C) is bisphenol-A.

7. The epoxy acrylate dispersion according to claim 1, wherein, step (i) is performed in the presence of the catalyst.

8. The epoxy acrylate dispersion according to claim 1, wherein, in step (i), the equivalent ratio is in the range of 1.5 to 50.

9. The epoxy acrylate dispersion according to claim 1, wherein in step (ii), the equivalent ratio is in the range of 1.8 to 2.2.

10. A method for coating a material with a radiation curable composition, comprising applying the epoxy acrylate dispersion according to claim 1 to said material being coated.

11. The method according to claim 10 wherein the material being coated is wood, metal, paper or cardboard.

12. A method for preparing an aqueous radiation-curable epoxy acrylate dispersion comprising
(a) an epoxy acrylate resin (P*) having at least 2 acrylate groups per molecule, which is not self-dispersing in water at 25° C., and
(b) a dispersant (D*) having at least one acrylate group per molecule, which method comprises the steps of:
(i) reacting one or more nonionic compounds (A), which have HLB value of less than 12 and at least two oxirane groups per molecule with one or more nonionic compounds (B), which have an HLB value in the range of 12 to 20 and at least one H-acidic groups (ZH) per molecule—optionally in the presence of a catalyst—wherein the compounds (A) and (B) present such that an equivalent ratio of EpO (A):ZH (B) is in the range of 1.3 to 400, to obtain a first reaction mixture;
(ii) reacting the first reaction mixture obtained in step (i) with one or more of said compounds (A) and with one or more nonionic compounds (C), which have an HLB value of less than 12 and at least two H-acidic groups (ZH) per molecule—optionally in the presence of a catalyst—wherein the compounds (A) and (C) are present such that an equivalent ratio EpO (A):ZH (C) is in the range of 1.1 to 20, to obtain a second reaction mixture;
(iii) reacting the second reaction mixture obtained in step (ii), with acrylic acid—optionally in the presence of a catalyst—under conditions of ring opening of all epoxy groups, to obtain a third reaction mixture; and
(iv) dispersing the third reaction mixture obtained in step (iii) in water.
